(19) United States
(12) Patent Application Publication
(10) Pub. No.: US 2022/0048469 A1
(43) Pub. Date: Feb. 17, 2022

(54) SYSTEM AND A METHOD OF PREVENTING UNAUTHORIZED ACCESS TO A VEHICLE

(71) Applicant: Autovisor PTE. LTD, Singapore (SG)

(72) Inventors: Dmitry Mikhailovich MIKHAILOV, Moscow (RU); Vadim Olegovich GRABINSKY, Moscow (RU); Alexey Sergeevich PRONICHKIN, Dimitrovgrad (RU)

(21) Appl. No.: 17/499,816

(22) Filed: Oct. 12, 2021

Related U.S. Application Data
(63) Continuation of application No. PCT/RU2020/050071, filed on Apr. 10, 2020.

(30) Foreign Application Priority Data
Apr. 12, 2019 (RU) 2019110951

(51) Int. Cl. B60R 25/24

(52) U.S. Cl. CPC B60R 25/245; B60R 2325/10

(57) ABSTRACT

The present invention relates to a system and method for preventing unauthorized access to a vehicle when setting up a controlled radio interference in specified frequency ranges and is designed to prevent an attacker from obtaining unauthorized access to the vehicle access control system. The system for preventing unauthorized access to the vehicle contains a key fob, a radio receiver of the vehicle and a device for setting radio interference installed inside the vehicle. The key fob contains a radio transmitter and is made with the ability to transmit data to a radio receiver in encoded form. The device for setting up radio interference is made with the possibility of installing radio interference in the frequency range of the data transmission channel between the key fob and the radon receiver of the vehicle. The technical result increases the safety of the vehicle from unauthorized access and theft, due to the provision of additional radar interference.

### FIELD

The present invention relates to a system and method for preventing unauthorized access to a vehicle when setting up controlled radio interference in specified frequency ranges and is designed to prevent an attacker from obtaining unauthorized access to the vehicle control system.

### BACKGROUND

Widespread digitalization and computerization, as a general trend in the development of modern society, has a double consequence. Positive trends are obvious—the introduction of new technologies is designed to make human life easier. Most of the functions previously performed by a person are shifted to computers and numerous control systems. This circumstance allows attackers various options for committing so-called cyber attacks. Such attacks are aimed at inflicting maximum material or physical damage to a person, society.

It is necessary to highlight such a direction as ensuring the safety of vehicles. This problem is becoming more and more relevant every day. This is due to the fact that the control systems of modern cars are becoming more and more autonomous. Almost all systems in the vehicle are now controlled by electronics: engine, brakes, cruise control, airbags, climate control, windscreen wipers, access control, etc.

Great attention is paid to ensuring the protection of various vehicle control systems. Many scientific articles have been written, there is a large number of implementations of protection methods that are implemented in keyless access systems of the vehicle.

There are various options for organizing keyless access systems of the vehicle, and, accordingly, the methods of protection. Different application options depend on the type of vehicle, manufacturer, year of manufacture, etc.

A vehicle access system is known from the prior art (RU2574478 C2, publ. Oct. 2, 2016) containing an access block made with the ability to control access to the vehicle through communication with an additional access block. The access block contains a transmitter for transmitting a questioning signal and a receiver for receiving an authentication signal from an additional access block in response to the above-mentioned questioning signal, while the transmitter is the first ultra-wide-band transmitter and the receiver is the first ultra-wide-band receiver. The transmitter is made with the ability to transmit in pulse mode a questioning signal with a variable interval between transmissions, and the transmitter is made with the ability to increase the interval between transmissions of the questioning signal in response to an increase in the distance between the access block and the additional access block and/or reduce the time interval between transmissions of the questioning signal in response to a decrease in the distance between the access block and an additional access block.

The disadvantage of this system is the vulnerability to listening to the radio broadcast between the receiver and the transmitter, as a result of which the signal of the contactless key to unlock the vehicle can be intercepted.

The closest analogue to the proposed invention is a system for the authentication of the use of a car according to the application WO 2007073969 A1, publ. May 7, 2007, and the specified system includes at least one transmitter and at least one receiver connected to each other by radio communication, while the frequency range of the radio line is in the ultra-wideband range.

The use of an ultra-wideband bottom band for data transmission provides increased reliability against unauthorized intrusion due to spectrum expansion technology.

The disadvantage of this system, as described above, is the vulnerability to listening to the radio ether between the receiver and the transmitter, as a result of which the signal of the contactless key to unlock the vehicle can be intercepted.

### SUMMARY

The objective of the invention is to develop a system that provides protection against cyber attacks on existing keyless access systems on modern vehicles.

The technical task is to increase the safety of the vehicle from unauthorized access and theft, by exposing additional radar interference.

The radio interference at the specified frequency does not allow an attacker to gain access to the control of the central lock of the vehicle by means of signal substitution.

The claimed technical result in terms of the system is achieved due to the fact that the system for preventing unauthorized access to the vehicle contains a keyFOB key, a radio receiver of the vehicle and a device for setting radio interference installed inside the vehicle, while the FOB key contains a radio transmitter and is designed to transmit data to the radio receiver in encoded form, and the device for setting up radio interference is made with the possibility of installing radio interference in the frequency range of the data transmission channel between the FOB key and the radio receiver of the vehicle.

The claimed technical result in terms of the method is achieved due to the fact that the method excludes the transmission of data from the FOB key to the radio receiver of the vehicle in encoded form at a given frequency range and radio interference and in the frequency range of the data transmission channel between the FOB key and the radio receiver of the vehicle.

### BRIEF DESCRIPTION OF THE DRAWINGS

The proposed invention is explained by drawings:

FIG. 1—shows the keyless access system to the vehicle (unidirectional mode);

FIG. 2—shows a keyless access system to the vehicle (unidirectional mode with cryptography);

FIG. 3—shows the keyless access system to the vehicle (bidirectional compression);

FIG. 4—shows the sequence of bytes from the FOB key to the radio receiver of the vehicle in normal operation;

FIG. 5—shows the sequence of bytes from the FOB key to the radio receiver of the vehicle in configuration mode;

FIG. 6—shows the spectrum of a radio signal with amplitude modulation and a carrier frequency of 1 kHz;

FIG. 7—illustrates the temporal representation of a radio signal with amplitude modulation and a carrier frequency of 1 kHz;

FIG. 8—illustrates the spectrum of the radio signal from frequency-modulated radio signals (in 2FSK mode);

FIG. 9—illustrates the temporal representation of frequency-modulated radio signals (in 2FSK mode);

FIG. 10—displays the spectrum of the LFM signal with a deviation of 20 kHz, a tuning speed of 1 kHz;

FIG. 11—illustrates the temporal representation of the chirp at zero frequency;

FIG. 12—displays a variant of the implementation of the system using the method of setting controlled radio interference.

### DETAILED DESCRIPTION OF THE NON-LIMITING EMBODIMENTS

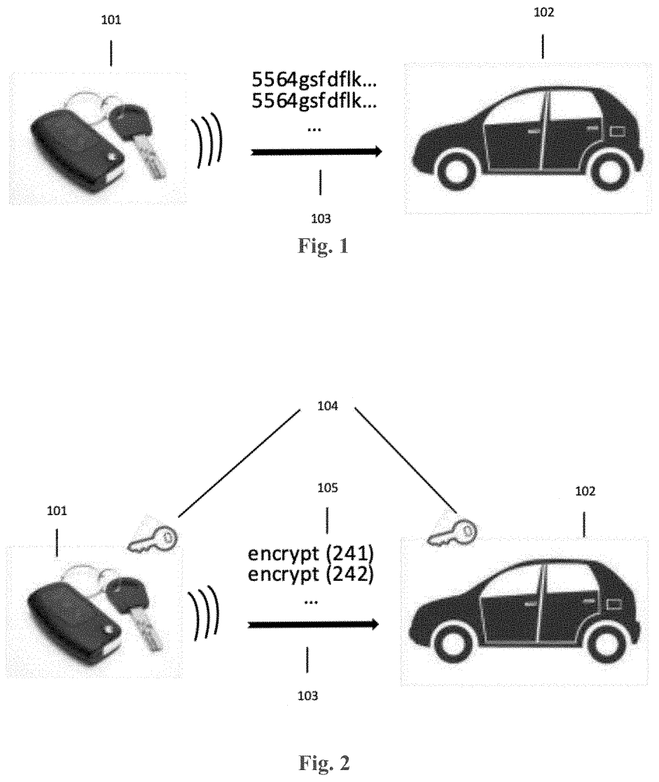

FIG. 1 shows a variant of the keyless access system (unidirectional mode). When using this mode, the owner of the vehicle using the FOB key 101 sends a fixed and always the same sequence of bytes via radio channel 103 to the radio receiver of the vehicle 102. When it is detected by the vehicle's radio receiver, one or another operation is performed (opening the closed doors, opening the luggage compartment, etc.).

FIG. 2 shows a variant of the keyless access system to the vehicle (unidirectional mode with cryptography). This option has become widespread and is the most widespread in terms of the number of visits. As in FIG. 1, the main components involved in data exchange are: FOB key 101; vehicle radio 102; radio channel 103. For this method, one of the following encryption algorithms is used (AES, XTEA, AUT64, etc.). The sequence of bytes 105 transmitted from the FOB key 101 to the radio receiver of the vehicle 102 has a field in which the digitized value of the internal counter is transmitted (as an example, FIG. 2 shows two encrypted values of epstupt (241) and epsturi (242), where the counter value corresponds to 241 and 242). After transmitting a sequence of bytes, the counter increments its value. Further, all sequences with a lower counter value are not fixed and discarded. Encoding/decoding of the counter value is performed using the secret key 104.

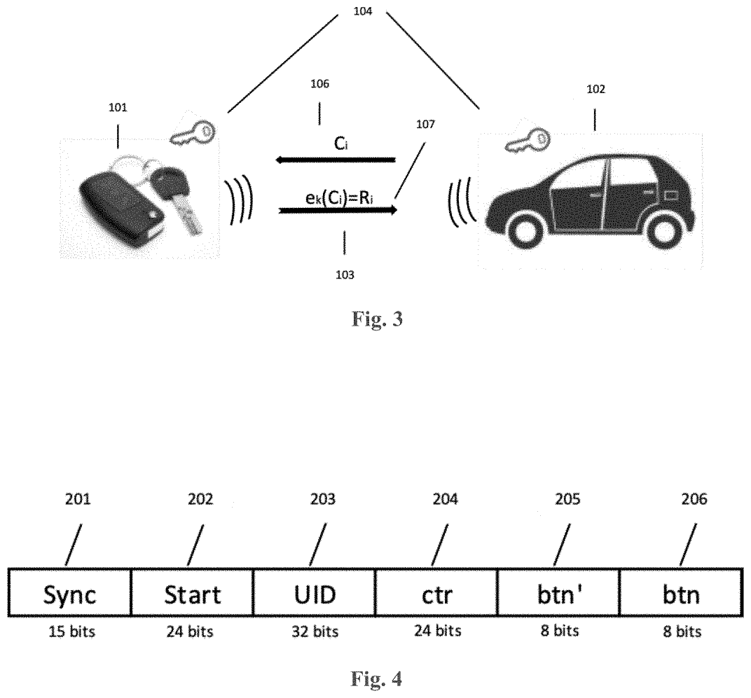

FIG. 3 conditionally shows a variant of the keyless access system to the vehicle (bidirectional mode). This mode represents the most convenient way for vehicle owners to work with the access control system. To open the central lock, it is enough for him to be in the range of the radio receiver of the vehicle 102. The algorithm of operation is the transmission of an arbitrary sequence of bytes of challenge 106 from the vehicle 102 to the radio receiver of the key fob 101. Further, encoding is performed inside the key fob 101 according to the established algorithm, and the resulting sequence of response 107 is sent to the radio channel for fixing it with the radio receiver of the vehicle 102. Encoding/decoding is performed using the secret key 104.

The system described in FIG. 1 is considered to be the most vulnerable. A sequence of operations from listening to the radio broadcast, copying, and then repeating a sequence of bytes by an attacker makes it possible to obtain unauthorized access to the vehicle.

The methods shown in FIGS. 2 and 3 also have their vulnerabilities and, under certain scenarios, allow an attacker to gain unauthorized access.

For a keyless access system (unidirectional mode with cryptography) with a known secret key 104, an attacker can generate the necessary sequences to control the central lock of the vehicle. An attack option is also possible, which consists in pre-recording the correct sequences from the key fob without affecting the radio receiver of the vehicle 102 and repeating them with direct impact on the radio receiver of the vehicle 102.

For a keyless access system (bidirectional mode), attackers use an attack type like fishing. This type of attack involves the organization of a data transmission channel between the key fob 101 receiver/transmitter of the vehicle 102. The attacker installs additional radio transmitting devices (which are not visible to the owner) between the key fob and the vehicle. Thus, the necessary communication channel is restored, using which it is possible to organize data transmission at the necessary moment, thereby obtaining unauthorized access to the control of the central lock of the vehicle.

In modern vehicles, a keyless access system to the vehicle is widely used for access control systems. The principle is based on the transmission of information between the key fob of the vehicle owner and the radio receiver of the electronic control unit (ECU) via a radio channel.

From the description presented above, it is obvious that the existing systems of keyless access to the vehicle, with all approaches to the complexity of their organization, are somehow susceptible to unauthorized hacking.

The present invention relates to a system and method of access to a vehicle by setting up controlled radio interference to prevent unauthorized access to the vehicle, namely the inability to control the central lock.

The novelty of the invention lies in the installation of radio interference inside the vehicle. Thus, it is not possible to detect external signals (byte sequences) by the radon receiver of the vehicle.

This is achieved due to the presence of radio interference, which does not allow radio wave detectors to restore the digital signal in an accurate form. As a consequence, there is no access to the access control system, namely, the ability to control the central lock, when setting up a radio interference.

The vehicle access system contains a key fob, a vehicle radio receiver and a device for setting up radio interference.

The key fob is essentially a standard alarm (installed by the car manufacturer) and can be combined with a physical ignition key. With the help of a key fob, the alarm is disarmed, as well as the condition of the car is monitored. In a number of alarm designs, remote engine start, control of electrical equipment, a car in a parking lot, etc., is carried out using a key fob. The key fob contains a radio transmitter and is made with the ability to transmit data to a radio receiver to a vehicle in encoded form. In some versions, the key fob, in addition to the radio transmitter, also contains a radio receiver. In this case, the keyless access system to the vehicle is capable of operating in the bidirectional mode described above (see FIG. 3). The device for setting up radio interference is installed inside the vehicle and is made with the possibility of installing radio interference in the frequency range of the data transmission channel between the key fob and the radio receiver of the vehicle, manufacturers use various frequency ranges from 70 to 1600 MHz for data transmission. In the preferred version of the invention, unlicensed frequency ranges of frequencies are used for data transmission, namely: 312-315 MHz, 433,075-434,750 MHz and 868.7-869.2 MHz.

The options for implementing the system and a method for preventing unauthorized access to a vehicle are described below using the example of a unidirectional cryptography mode. This mode has the largest number of implementations for vehicle access control systems. However, all the principles described in this technical solution are applicable to other modes.

Based on the results of the tests, as well as information obtained from open sources, it was found that data transmission (testing with cars, restoring signals transmitted over the radio channel, etc.) is unidirectional. The key fob 101 in its composition has a radio transmitter or a radio transmitter from radios, and the ECU of the vehicle is a radio receiver. Considering the option of transmitting data at a non-dry frequency of 434.25 MHz with amplitude modulation. The data is transmitted in Manchester encoding at a speed of ˜1,667 kbit/s (i.e., a bit duration of 600 microseconds). Data is transmitted in encoded form (possible encoding algorithms XTEA. AUT64).

FIG. 4 shows one of the variants of the byte sequence from the key fob to the radio receiver of the vehicle in normal operation. The sequence has the following fields:
Sync (201) synchronizing sequence field=15 bits;
Start (202) transmitting information start field=24 bits;
UID (203) key identifier field=32 bits;
10 cir (204) current command counter field=24 bits;
btn′ (205) button code identifier field=8 bits (encoded);
btn (206) button code identifier field=8 bits (not encoded).

By pressing the button on the key fob once, 3 identical sequences are transmitted (duplication).

FIG. 5 shows one of the variants of the byte sequence from the key-15 of the key fob to the radio receiver of the vehicle in configuration mode (long hold of any button). This mode is used to bind a new key to the vehicle. The sequence has the following fields
Sync (201) synchronization sequence field −15 bits;
UID (203) key identifier field=32 bits;
btn (206) button code identifier field=8 bits (not encoded).

In configuration mode, the byte sequence is repeated each time and does not contain encoded information.

The setting of controlled radio interference will be effective regardless of the type of modulation used, the data transfer rate, the composition of the fields, the transmitted byte sequence.

Effective suppression of control commands from the key fob is possible using signal-like interference with a power of −5 dBm within a radius of 10 m (subject to line of sight). As a signal-like radio interference in the proposed method of operation, various options can be used. Below is a description using the LFM signal (linear frequency modulation) as radio interference.

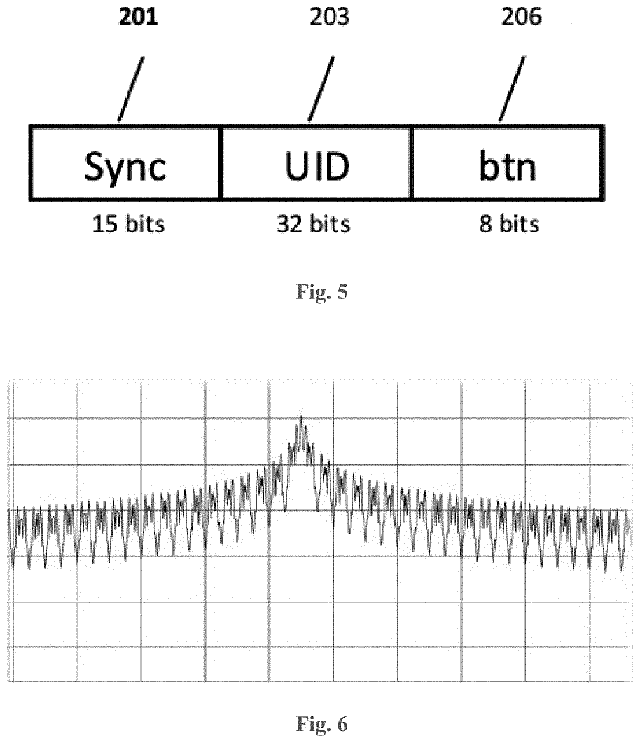

FIGS. 6-9 show the signal spectra of various types of modulations that can be used to transmit byte sequences from the key fob to the vehicle.

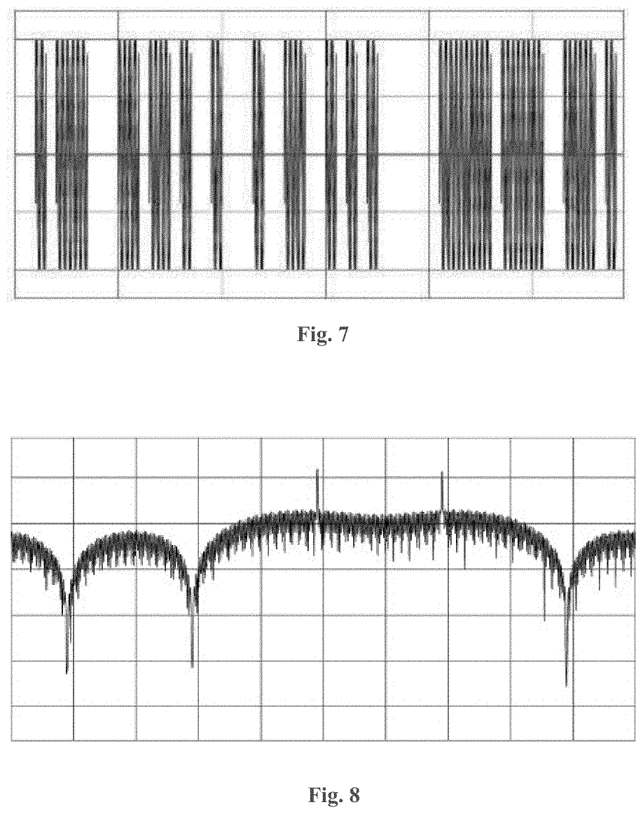

For radio signals with amplitude modulation and a carrier frequency of 1 kHz with a bitrate of −0.5 kbps, its spectrum in the frequency domain is shown in FIG. 6, and in FIG. 7 in a variable representation.

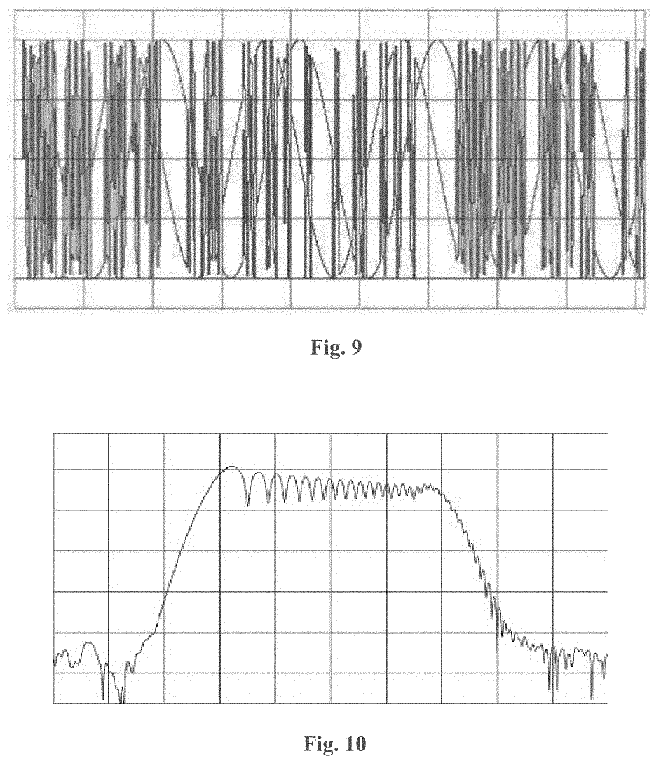

For radio signals with frequency modulation (in 2FSK mode) and a bitrate of −20 kbps, the spectrum is shown in FIG. 8 (with the lower frequency detuned by 1 kHz to the left relative to the constant component), in a variable representation in FIG. 9.

The LFM signal is used as a universal radio interference signal. This signal has the following characteristics:
The deviation of the exposed signal is 20 kHz;
The tuning speed is 1 kHz;
Ranges: 312-315 MHz, 433,075-434, 750 MHz and 868.7-869.2 MHz;
The power characteristics −5 lBm;
Radius—10 m (with a conditional line of sight)

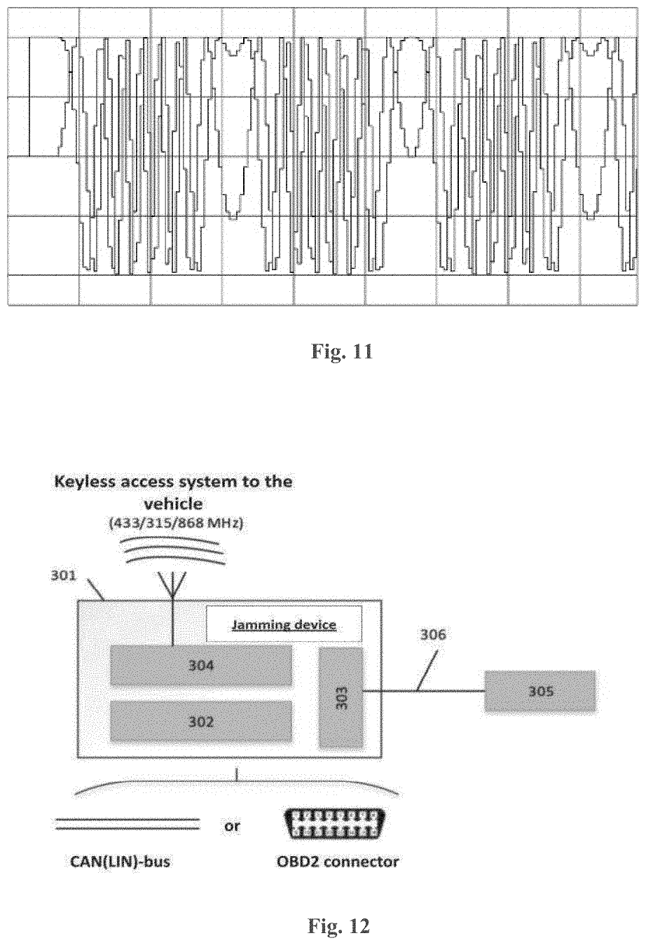

FIG. 10 shows the spectrum of the LFM signal with the specified characteristics, and FIG. 11 shows the time representation of the LFM signal at zero frequency.

The main functional purpose of the device is the setting of radio interference in a given frequency range of the communication channel of the key fob and the vehicle. The device is installed inside the vehicle, and the level of the interference signal is selected so as to affect only the radar receiver of this vehicle. This 5-10 are done by adjusting the transmitter power of the device −5-10 dBm.

The activation of the jammer (activation deactivation of the “Security” mode) is performed via a different communication channel than the radio channel on which the interference of the standard alarm system (WiFi, GSM, Bluetooth, etc.) is installed.

It is possible to control the central lock of the vehicle access control system without deactivating the “Security” mode, through the device issuing the appropriate command on the electric information bus of the vehicle. Exposed radio interference.

The exposed radio interference is an additional circuit of protection against unauthorized access to the vehicle access system, and in particular to the control of the central lock.

The principle of operation is that the owner of the vehicle, in addition to using other means that provide protection against theft (alarm, immobilizer), activates the device 301 to install radio interference. The device exposes radio interference at the frequency of operation of the vehicle access system, the attacker, when trying to gain access to the central locks of the uncontrolled access system, is refused, because the sequences exposed by it are not detected by the vehicle receiver due to the radio interference. The owner can deactivate the interference by communicating with the device via other communication channels (GSM, BLE, WiFi, etc.) Additionally, other algorithms for activating/deactivating the “Protection” mode can be prescribed and implemented (depends on the use and connection option).

FIG. 12 shows the functional diagram of the connection and operation of the device 301 for installing radio interference. The 301 device contains the following modules:

The interface and control module 302 of the device 301 is designed to interface the device 301 with the electrical information bus of the vehicle. Provides data reading from it, as well as setting its own data. Interfaces, as well as the type of connection depend on the vehicle or the design of the device (direct connection to the CAN (LIN) electrical information bus of the vehicle; connection via the OBD2 connector)

The access module 303 of the device 301 are designed to organize a communication channel with the user's portable device (smartphone, tablet computer, laptop, etc.). Information transmission via one of the available communication channels 36), such as: WiFi, GSM, Bluetooth, etc. The communication channel 306 is intended for: parameterization and control of the device 301, reading of service information, log files, etc.

The radio transmitter module 304 is a transceiver device that is designed to operate in the specified frequency ranges (depending on the selected type of vehicle and the tasks to be solved).

Module 304 determines the frequency range at which data is transmitted between the key fob and the radio receiver. At the initial moment of time, before installing the device 301 in the vehicle, the frequency at which the system of uncontrolled access to the vehicle operates is determined (this parameter may differ for each vehicle). After setting this parameter, the radio transmitter module 304 will detect interference in the specified frequency range.

Module 304 is required to perform 2 main functions:
Listening to the selected frequency range, including identification of the “open doors” command;
Interference in the selected frequency range in the case of setting the vehicle in the “Guard” mode.

This device can be implemented:
As a standalone device
And as part of the system (as an integral part of the complex).

The module 305 is a device for the owner of the vehicle. Using this device the owner performs activation/deactivation and performs configuration using the device 301.

1. A system for preventing unauthorized access to a vehicle, the system comprising:
a key fob,
a vehicle radio receiver; and
a device for setting radio interference installed inside the vehicle,
the key fob having a radio transmitter and being configured for transmitting data to the radio receiver in an encoded form, and
the device for setting radio interference being configured for generating radio interference in a frequency range of a data transmission channel between the key fob and the radio receiver of the vehicle.

2. The system, according to claim 1 wherein the device for setting up radio interference is connected to the electrical information bus of the vehicle.

3. The system, according to claim 1, wherein the installation of radio interference is carried out at unlicensed frequencies, namely: 312-315 MHz, 433.075 434.750 MHz, 868.7-869.2 MHz.

4. A method for preventing unauthorized access to a vehicle, the method comprising:
transmitting data from a key fob to a radio receiver of the vehicle in an encoded form at a given frequency range,
setting up a radio interference in the frequency range of a data transmission channel between the key fob and the radio receiver of the vehicle.
